(19) United States
(12) Patent Application Publication
(10) Pub. No.: US 2008/0254685 A1
(43) Pub. Date: Oct. 16, 2008

(54) Receptacle connector assembly for reducing EMI and/or crosstalk

(75) Inventors: Keith McQuilkin Murr, York, PA (US); Michael Engene Shirk, Grantville, PA (US); Michael W. Fogg, Harrisburg, PA (US)

Correspondence Address: Robert J. Kapalka;Tyco Electronics Corporation, Suite 140, 4550 New Linden Hill Road, Wilmington, DE, 19808-2952, US

(73) Assignee: Tyco Electronics Corporation

(21) Appl. No.: 11/786,924

(22) Filed: Apr. 13, 2007

(51) Int. Cl. H01R 24/00

(52) U.S. Cl. 439/676; 439/607

(57) ABSTRACT

A contact sub-assembly is provided for a receptacle connector assembly. The contact sub-assembly includes a housing that includes a body fabricated at least partially from a dielectric material. A plurality of electrical contacts are held by the housing. Each of the electrical contacts has a mating end portion, a tail end portion opposite the mating end portion, and an intermediate portion extending between the mating and tail end portions. The intermediate portions of each of the electrical contacts include an edge. The edge of at least one of the intermediate portions has an indentation therein extending along a portion of a length of the edge.

### BACKGROUND OF THE INVENTION

This invention relates generally to electrical connectors, and more particularly, to a receptacle connector assembly that may facilitate reducing EMI and/or crosstalk.

Various electronic systems, such as those used to transmit signals in the telecommunications industry, include connector assemblies that transmit signals in differential pairs. One electrical contact of the differential pair carries a positive signal and the other electrical contact carries a negative signal intended to have the same absolute magnitude, but at an opposite polarity. An RJ-45 electrical connector is one example of a connector used to transmit electrical signals in differential pairs. RJ-45 connectors include a plug and a receptacle connector assembly, sometimes referred to as an outlet jack, which receives the plug.

RJ-45 plugs typically have four differential pairs of wires. However, the plug may have an undesirable level of noise due to the arrangement of the wires as determined by industry standards. Within the receptacle connector assembly, multiple differential pairs of electrical contacts are positioned in close proximity to each other. The close proximity of the differential pairs may generate electromagnetic interference (EMI) and/or unwanted electromagnetic (EM) signal coupling, or cross-talk, between adjacent differential pairs. EMI and cross-talk between adjacent differential pairs may degrade the quality of the signals transmitted by the receptacle connector assembly. Additionally, connector assemblies are being used to transmit data across higher frequencies and wider bandwidths. As frequencies increase, the connector assemblies may experience even more signal degradation due to EMI and/or cross-talk between adjacent differential pairs.

Receptacle connector assemblies are sometimes mounted on a circuit board to enable electrical connection between the plug and the circuit board. Receptacle connector assemblies are typically mounted on the circuit board before high-temperature processing of other components of the circuit board. Some receptacle connector assemblies include light emitting diodes (LEDs) to indicate a status of the connector assemblies, such as whether the plug is operationally mated to the receptacle connector assembly and/or whether the receptacle connector assembly is operational. However, in order to survive the high temperature processing, the LEDs may include more complex and/or expensive components, such as electrical contacts that electrically connect to the receptacle connector assembly, than would otherwise be used.

A need therefore exists for a receptacle connector assembly that reduces or eliminates EMI and/or cross-talk. A need also exists for a receptacle connector assembly having LEDs with less complex and/or expensive components.

### BRIEF DESCRIPTION OF THE INVENTION

In one embodiment, a contact sub-assembly is provided for a receptacle connector assembly. The contact sub-assembly includes a housing that includes a body fabricated at least partially from a dielectric material. A plurality of electrical contacts are held by the housing. Each of the electrical contacts has a mating end portion, a tail end portion opposite the mating end portion, and an intermediate portion extending between the mating and tail end portions. The intermediate portions of each of the electrical contacts include an edge. The edge of at least one of the intermediate portions has an indentation therein extending along a portion of a length of the edge.

In another embodiment, a contact sub-assembly is provided for a receptacle connector assembly. The contact sub-assembly includes a housing comprising a body fabricated at least partially from a dielectric material, and a plurality of electrical contacts held by the housing. Each of the electrical contacts has a mating end portion, a tail end portion opposite the mating end portion, and an intermediate portion extending between the mating and tail end portions. An EMI compensation member is held at least partially within the housing and includes a body fabricated at least partially from an electrically conductive material. The EMI compensation member faces the intermediate portion at least one of the electrical contacts.

In another embodiment, a receptacle connector assembly is provided. The receptacle connector assembly includes a front housing extending between front and rear end portions. The front end portion is configured to receive a plug. A contact sub-assembly is held by the front housing. The contact sub-assembly includes a sub-assembly housing having a body fabricated at least partially from a dielectric material. A plurality of electrical contacts are held by the sub-assembly housing. Each of the electrical contacts has a mating end portion, a tail end portion opposite the mating end portion, and an intermediate portion extending between the mating and tail end portions. A light emitting diode (LED) is connected to at least one of the front housing and the contact sub-assembly in a press-fit arrangement.

### BRIEF DESCRIPTION OF THE DRAWINGS

FIG. 1 is a perspective view of an exemplary embodiment of a receptacle connector assembly.

FIG. 2 is a perspective view of an exemplary embodiment of a housing of the receptacle connector assembly shown in FIG. 1.

FIG. 3 is a perspective view of an exemplary embodiment of a contact sub-assembly of the receptacle connector assembly shown in FIG. 1.

FIG. 4 is an exploded perspective view of a portion of the contact sub-assembly shown in FIG. 3.

FIG. 5 is a top plan view of an exemplary alternative embodiment of an electrical contact that may be used with the contact sub-assembly shown in FIGS. 3 and 4.

FIG. 6 is a perspective view of the contact sub-assembly shown in FIGS. 3 and 4 illustrating a light emitting diode (LED) engaged with and electrically connected to the contact sub-assembly.

FIG. 7 is a partially exploded perspective view of an exemplary alternative embodiment of a receptacle connector assembly.

### DETAILED DESCRIPTION OF THE INVENTION

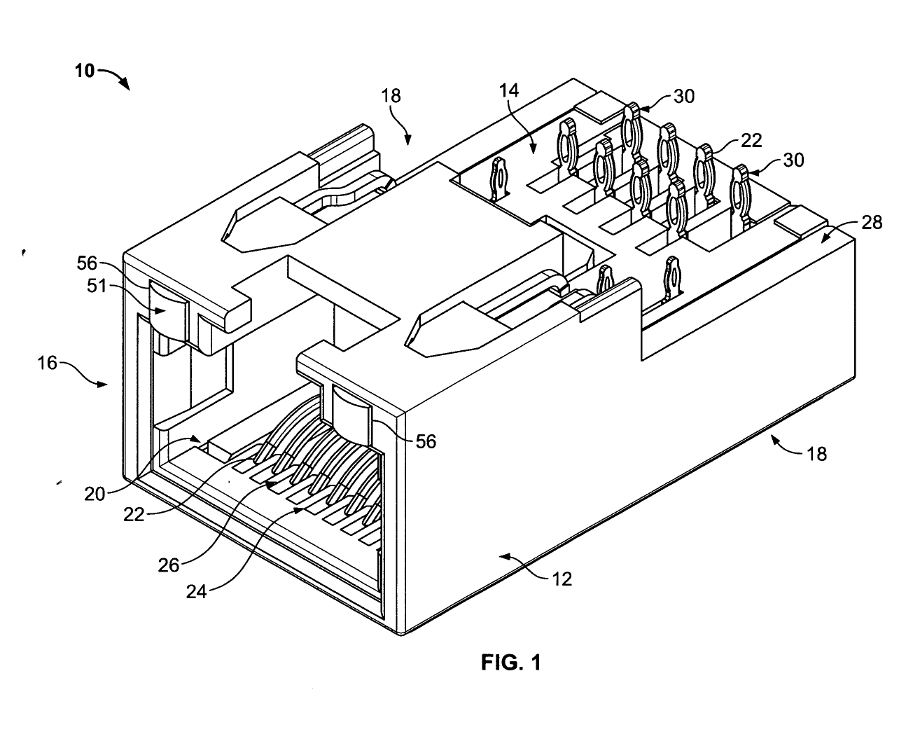

FIG. 1 is a perspective view of an exemplary embodiment of a receptacle connector assembly 10. The receptacle connector assembly 10 includes a housing 12 and a contact sub-assembly 14. The housing 12 may be referred to herein as a front housing. The housing 12 extends between a front end portion 16 and an opposite rear end portion 18. The housing 12 includes a cavity 20 that extends through the front end portion 16. The contact sub-assembly 14 holds a plurality of electrical contacts 22 in an array 24. The contact sub-assembly 14 is mated with the housing 12 through the rear end portion 18 such that mating end portions 26 of the electrical contacts 22 are exposed within the cavity 20.

In the example of FIG. 1, the cavity 20 accepts an RJ-45 plug (not shown) inserted through the front end portion 16. Alternatively, the cavity 20 may accept other types of plugs. The RJ-45 plug has a plurality of electrical contacts (not shown) that each electrically connect with the mating end portion 26 of a corresponding one of the electrical contacts 22 of the contact sub-assembly 14. In the exemplary embodiment, the receptacle assembly 10 is configured to be mounted on a circuit board (not shown). Specifically, the receptacle connector assembly 10 includes a mounting face 28 that engages the circuit board. As will be described in more detail below, the mounting face 28 is defined by a portion of the contact sub-assembly 14. Tail end portions 30 of each of the electrical contacts 22 of the contact sub-assembly 14 extend along the mounting face 28. The tail end portions 30 engage corresponding electrical contacts (not shown) on the circuit board to electrically connect the receptacle assembly 10 to the circuit board. Alternatively, the receptacle connector assembly 10 is configured to be mounted on the end of a cable (not shown). Specifically, in such an alternative embodiment, the receptacle connector assembly 10 may include a wire receiving portion (not shown) that receives a plurality of wires (not shown) of the cable; and each of the tail end portions 30 extends along the wire receiving portion for electrical connection with a corresponding one of the wires.

Optionally, a shield (not shown in FIG. 1) fabricated at least partially from an electrically conductive material may surround at least a portion of the receptacle connector assembly 10. For example, the shield may surround at least a portion of the housing 12 and/or the contact sub-assembly 14.

It should be understood that the housing 12, the contact sub-assembly 14, and/or the receptacle connector assembly 10 may vary in size, depending on customer specifications. For example, it may be desirable to make the receptacle connector assembly 10 as small or compact as possible.

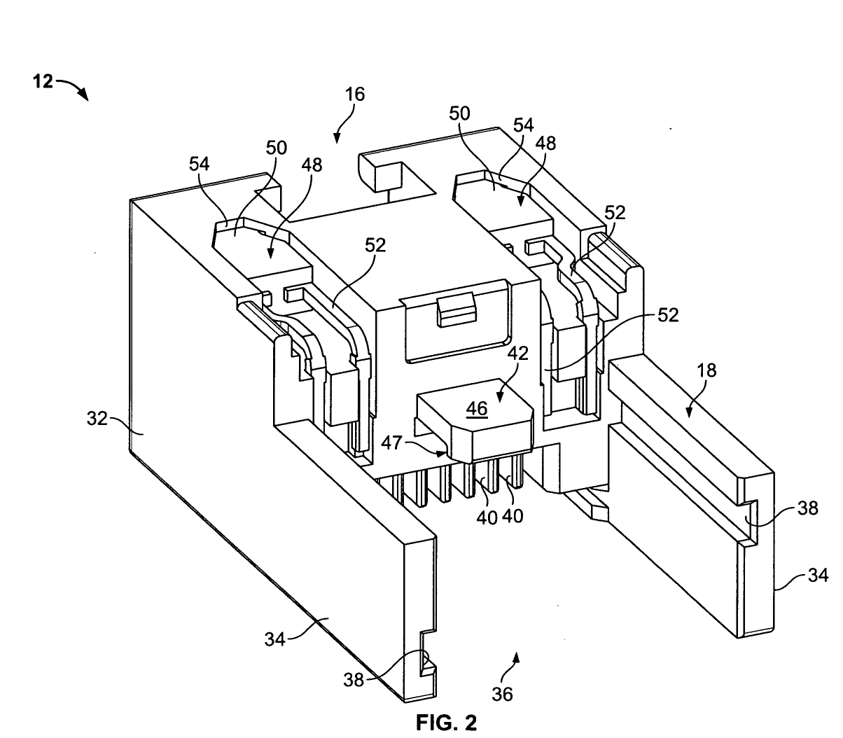

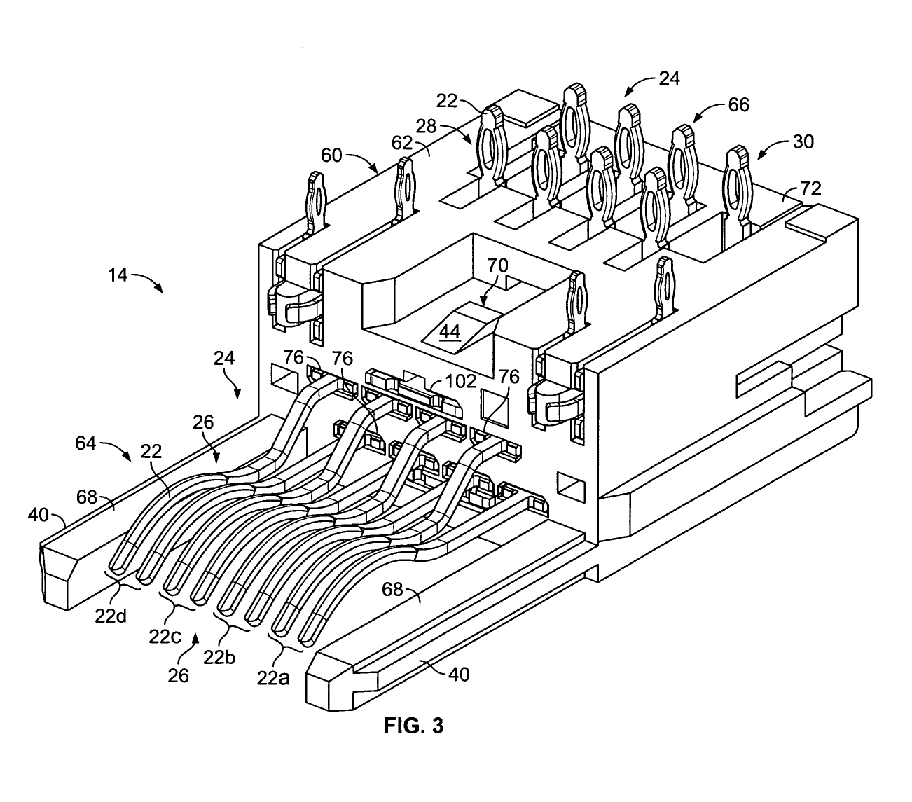

FIG. 2 is a perspective view of the housing 12. The housing 12 includes a body 32 extending between the front and rear end portions 16 and 18, respectively. The housing body 32 is fabricated at least partially from a dielectric material. The housing body 32 includes a pair of opposite legs 34 that define an opening 36 at the rear end portion 18 for receiving a portion of the contact sub-assembly 14 (FIGS. 1, 3, and 4). The legs 34 may optionally include alignment slots 38 that each cooperate with an alignment projection 40 (FIG. 3) of the contact sub-assembly 14 to facilitate aligning the contact sub-assembly 14 with the housing 12 during mating thereof. In addition or alternative, one or both of the legs 34 of the housing 12 may include an alignment projection (not shown) that cooperates with an alignment slot (not shown) within the contact sub-assembly 14.

The housing body 32 also includes a plurality of openings 40 that each receive a corresponding one of the electrical contacts 22 (FIGS. 1, 3, and 4) of the contact sub-assembly 14 therein. The openings 40 may facilitate supporting the electrical contacts 22 to facilitate holding the mating end portions 26 (FIGS. 1, 3, and 4) of the electrical contacts 22 in position within the assembly 10, for example during mating of the housing 12 and the contact sub-assembly 14 and/or during mating of the receptacle connector assembly 10 (FIG. 1) with the RJ-45 plug. Although eight openings 40 are shown, the housing body 32 may include any number of openings 40 for receiving any number of electrical contacts 22.

The housing body 32 includes a latch member 42 that mates with a latch member 44 (FIGS. 3-5) of the contact sub-assembly 14 to latch the contact sub-assembly 14 to the housing 12. The latch member 42 may have any suitable configuration, structure, means, and/or the like that enables the latch member 42 to function as described and/or illustrated herein. In the exemplary embodiment, the latch member 42 includes a deflectable body 46 that includes a hook portion 47 that engages the latch member 44 of the contact sub-assembly 14. Moreover, although only one latch member 42 is shown, the housing body 32 may include any number of latch members 42 that mate with any number of latch members 44 of the contact sub-assembly 14.

Optionally, a plurality of light emitting diodes (LEDs) 48 are held by the receptacle connector assembly 10. The LEDs 48 may indicate a status of the receptacle connector assembly 10, such as, but not limited to, whether the RJ-45 plug is operationally mated to the receptacle connector assembly 10 and/or whether the receptacle connector assembly 10 is operational, such as, but not limited to, whether the assembly 10 is operationally mounted on the circuit board (not shown) or is operationally connected to the cable (not shown). The LEDs 48 each include a body 50 and a pair of electrical contacts 52 extending outward from the body 50. In the exemplary embodiment, each LED body 50 is held within a pocket 54 of the housing body 32. Alternatively, each LED body 50 is held by the contact sub-assembly 14, or each LED body 50 is jointly held by the housing 12 and the contact sub-assembly 14. Although two LEDs 48 are shown, the receptacle connector assembly 10 may include any number of LEDs 48 for indicating any number of different statuses.

The housing body 32 includes a pair of openings 56 (FIG. 1) extending through the front end portion 16 and intersecting a corresponding one of the pockets 54. An end portion 51 (FIG. 1) of each of the LED bodies 50 that emits light extends partially through the corresponding opening 56 to emit light along the front end portion 16 of the housing 12 such that the indicated status can be viewed by a user facing the front end portion 16. Alternatively, the end portion 51 of one or more of the LED bodies 50 does not extend through the corresponding opening 56 but is aligned with the opening to emit light through the opening 56 such that the indicated status can be viewed by a user facing the front end portion 16 of the housing 12. As will be described in more detail below, in the exemplary embodiment the electrical contacts 52 of each LED 48 engage and electrically connect to corresponding electrical contacts 58 (FIGS. 3, 4, 6, and 7) held by the contact sub-assembly 14.

The LED bodies 50 may each be held by the housing 12 using any suitable configuration, structure, means, and/or the like. In the exemplary embodiment, each LED body 50 is held by the housing body 32 using a press-fit arrangement. Specifically, each body 50 is sized and shaped relative to the corresponding pocket 54 such that the LED body 50 is held within the pocket 54 using stiction and/or friction. Other examples of holding the LED bodies 50 include, but are not limited to, using adhesive, and/or using one or more latching members and/or openings on the housing body 32 and/or the LED body 50.

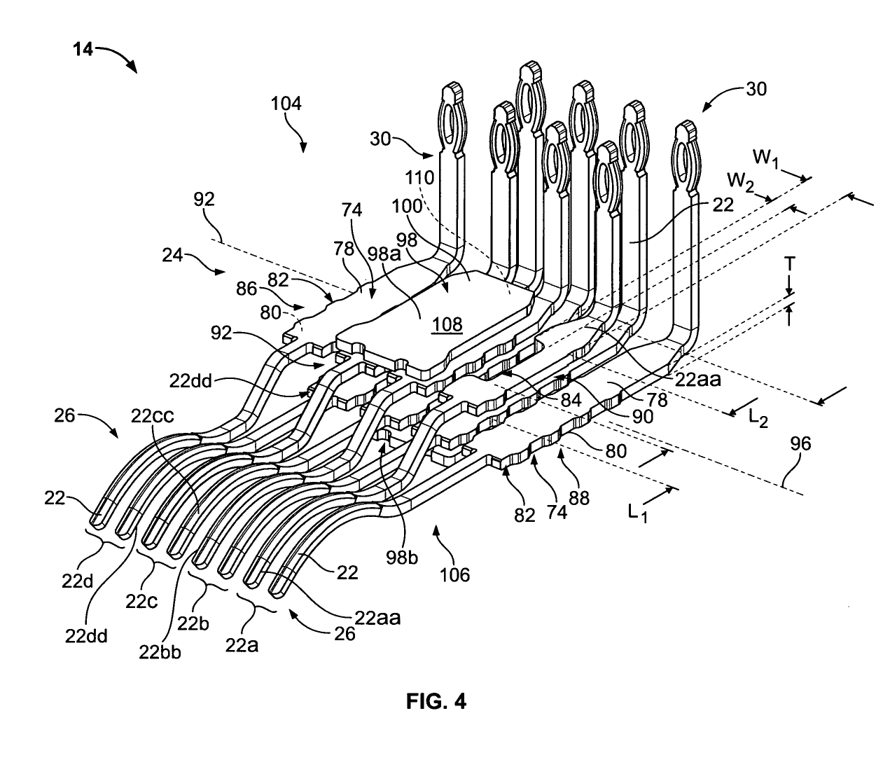

FIG. 3 is a perspective view of an exemplary embodiment of the contact sub-assembly 14. FIG. 4 is an exploded perspective view of a portion of the contact sub-assembly 14 illustrating the array 24 of electrical contacts 22. The contact sub-assembly 14 includes a housing 60 having a body 62 extending from a front end portion 64 and a rear end portion 66. The housing 60 may be referred to herein as a contact sub-assembly housing. The housing body 62 is fabricated at least partially from a dielectric material.

The housing body 62 includes a pair of alignment members 68 extending outwardly on the front end portion 64 of the housing body 62. The alignment members 68 each include one of the alignment projections 40 that cooperates with a corresponding one of the alignment slots 38 (FIG. 2) of the housing 12 to facilitate aligning the contact sub-assembly 14 with the housing 12 (FIG. 2) during mating thereof. The housing body 62 also includes the latch member 44 that mates with the latch member 42 (FIG. 2) of the housing 12 to latch the contact sub-assembly 14 to the housing 12. The latch member 44 may have any suitable configuration, structure, means, and/or the like that enables the latch member 44 to function as described and/or illustrated herein. In the exemplary embodiment, the latch member 44 includes a hook portion 70 that engages the hook portion 47 (FIG. 2) of the latch member 42. Optionally, a rear cover 72 may be mounted on the rear end portion 66 of the housing body 62 using any suitable structure, means, and/or the like.

The housing body 62 holds the plurality of electrical contacts 22 in the array 24. Each of the electrical contacts 22 includes the mating and tail end portions 26 and 30, respectively, and an intermediate portion 74 extending between the mating and tail end portions 26 and 30, respectively. The mating end portions 26 of the electrical contacts 22 extend along the front end portion 64 of the housing body 62. Each intermediate portion 74 of the electrical contacts 22 extends through a corresponding opening 76 within the housing body 62 to the corresponding tail end portion 30, which extends along the mounting face 28 of the housing body 62. At least a portion of the intermediate portions 74 engage the housing body 62 within the corresponding opening 76 to facilitate holding the electrical contacts 22 in position relative to the housing body 62. In the exemplary embodiment, the electrical contacts 22 are arranged in differential pairs 22a, 22b, 22c, and 22d, wherein each electrical contact 22 carries a differential pair signal. Alternatively, the electrical contacts 22 are not arranged in differential pairs.

In the exemplary embodiment, the tail end portions 30 of each of the electrical contacts 22 are configured as eye-of-the needle contacts. However, the tail end portions 30 of the electrical contacts 22 may each be configured as any suitable type of electrical contact, such as, but not limited to, pin contacts and/or insulation displacement contacts (IDCs). The mating end portions 26 of the electrical contacts 22 may also each be configured as any suitable type of electrical contact, such as, but not limited to, pin contacts, eye-of-the needed contacts, and/or IDCs. In the exemplary embodiment, the tail end portions 30 of the electrical contacts 22 extend along the mounting face 28 in a direction substantially perpendicular to a direction at which the mating end portions 26 of the electrical contacts 22 extend. However, the tail end portions 30 may extend any direction relative to the mating end portions 26, such as, but not limited to, substantially parallel. Although eight electrical contacts 22 are shown, the contact sub-assembly 14 may hold any number of electrical contacts 22.

Referring now to FIG. 4, in the exemplary embodiment each of the intermediate portions 74 of the electrical contacts includes a pair of substantially planar surfaces 78 and 80 extending opposite one another. An edge 82 extends between the surfaces 78 and 80. Optionally, the edge 82 of the intermediate portion 74 of two of the electrical contacts 22aa and 22dd has an indentation 84 therein that extends along a portion of a length L of the edge 82. The electrical contact 22aa is one of the electrical contacts of the differential pair 22a, while the electrical contact 22dd is one of the electrical contacts of the differential pair 22d. As used herein, the term “indentation” is intended to mean a concave cut, notch, recess, slot, opening, hollowed-out place, and/or the like within an edge. The indentations 84 facilitate reducing or eliminating electrical coupling, or cross-talk, between adjacent electrical contacts 22, and in the exemplary embodiment between adjacent differential pairs of the electrical contacts 22. For example, the indentations 84 may reduce cross-talk by increasing the distance between a portion the electrical contact 22 having the indentation 84 and adjacent electrical contacts 22 and/or adjacent differential pairs of the electrical contacts 22. The indentation 84 removes material from the corresponding electrical contact 22 to provide space between adjacent electrical contacts 22 to facilitate reducing or eliminating side-to-side cross-talk between adjacent electrical contacts 22. Alternatively, none of the electrical contacts 22 include an indentation 84 therein.

Although two of the electrical contacts 22 are shown as having indentations 84, any number of the electrical contacts 22 may have an indentation 84 within the corresponding intermediate portion 74. Moreover, the electrical contacts 22 that include indentations 74 may be located anywhere within the array 24 that enables the indentations 84 to reduce cross-talk between adjacent contacts 22 and/or between adjacent differential pairs of the contacts 22. In the exemplary embodiment, the array 24 of the electrical contacts 22 includes a pair of rows 86 and 88 of the intermediate portions 74. The electrical contact 22aa having the indentation 84 is located on the end 90 of the row 86, while the electrical contact 22dd having the indentation 84 is located on the end 92 of the row 88. The indentation 84 within the electrical contact 22aa faces the intermediate portion 74 of an electrical contact 22bb of the differential pair 22b and thereby facilitates reducing or eliminating cross-talk between the differential pairs 22a and 22b, while the indentation 84 within the electrical contact 22dd faces the intermediate portion 74 of an electrical contact 22cc of the differential pair 22c and thereby facilitates reducing or eliminating cross-talk between the differential pairs 22c and 22d.

The indentations 84 may each be of any size that enables the indentations 84 to facilitate reducing or eliminating cross-talk between adjacent contacts 22 and/or between adjacent differential pairs of the contacts 22. Each indentation 84 may also be located anywhere on the intermediate portion 74 of the corresponding electrical contact 22 that enables the indentations 84 to facilitate reducing or eliminating cross-talk between adjacent contacts 22 and/or between adjacent differential pairs of the contacts 22. In the exemplary embodiment, the indentations 84 each extend a length L₂ within the intermediate portion 74 of the corresponding electrical contact 22 that is about half of a length L₁ of the intermediate portion 74. Moreover, in the exemplary embodiment, each of the indentations 84 extends a depth D into the edge 82 of the intermediate portion 74 of the corresponding electrical contact 22 that is about half of a width W₁ of the intermediate portion 74. In the exemplary embodiment, each indentation 84 removes about 25% of the surface area of each of the surfaces 78 and 80 of the corresponding intermediate portion 74 as compared with the intermediate portions 74 that do not include an indentation 84. Other examples of suitable lengths L₂ of the indentations 84 include between about 25% and about 50% of the length L₁ of the corresponding intermediate portion 74, and between about 50% and about 100% of the length L₁ of the corresponding intermediate portion 74. Other examples of suitable depth D of the indentations 84 include between about 25% and about 50% of the width W₁ of the corresponding intermediate portion 74, and between about 50% and about 75% of the width W₁ of the corresponding intermediate portion 74. Although each indentation 84 extends completely through a thickness T of the intermediate portion 4 of the corresponding electrical contact 22, one or more indentations 84 may alternatively extend only partially through the thickness T of the corresponding electrical contact 22.

The indentations 84 may each be of any suitable shape that enables the indentations 84 to facilitate reducing or eliminating cross-talk between adjacent contacts 22 and/or between adjacent differential pairs of the contacts 22. In the exemplary embodiment, each of the indentations 84 has a generally rectangular shape. Other examples include, but are not limited to, arcuate shapes, a combination of rectangular and arcuate shapes, and/or the like.

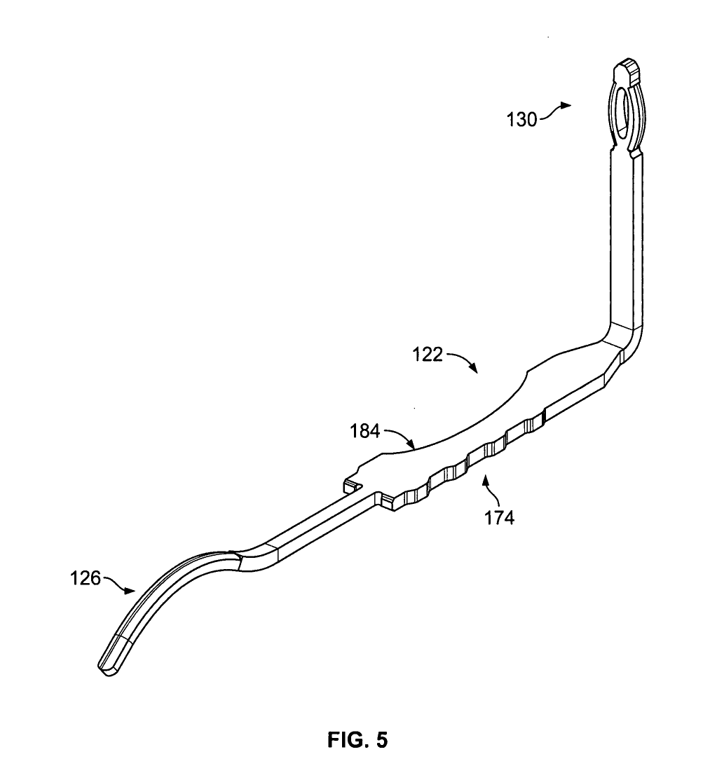

FIG. 5 illustrates an exemplary alternative embodiment of an electrical contact 122 that includes an exemplary alternative embodiment of an indentation 184. Specifically, the electrical contact 122 includes a mating end portion 126, a tail end portion 130, and an intermediate portion 174 extending between the mating and tail end portions 126 and 130, respectively. The intermediate portion 174 includes the indentation 184, which has an arcuate shape.

Referring again to FIGS. 3 and 4, the intermediate portion 74 of each of the electrical contacts 22 is not limited to the shape described and illustrated herein, but rather may have any suitable shape that enables the electrical contacts 22 to function herein and that enables the intermediate portion 74 of at least one of the electrical contacts 22 to have an indentation (e.g., the indentation 84) as described and/or illustrated herein. Moreover, the mating end portion array 24 of the electrical contacts 22 is not limited to the pattern shown herein, but rather may have any suitable pattern, configuration, arrangement, and/or the like that enables the receptacle connector assembly 10 (FIG. 1) to function as described herein. In the exemplary embodiment, each of the intermediate portions 74 of the electrical contacts 22 within each row 86 and 88 is aligned along a longitudinal axis 94 and 96 of the respective row 86 and 88. However, the electrical contacts 22 within the row 86 or 88 may alternatively be staggered about opposite sides of the respective axis 94 and 96. Although two rows 86 and 88 are shown, the array 24 may include any number of rows. Optionally, the electrical contacts 22 may have a predetermined arrangement (e.g., a position, spacing, cross-over, and/or the like) to control the signal integrity and/or performance of the receptacle connector assembly 10.

Optionally, the housing body 62 holds a pair of EMI compensation members 98 at least partially within the housing body 62. The EMI compensation members 98 each comprises a body 100 fabricated at least partially from an electrically conductive material. The EMI compensation members 98 are held by the housing body 62 such that the EMI compensation members face the intermediate portion 74 of at least one of the electrical contacts 22 to facilitate reducing or canceling excess signal noise of the array 24 of the electrical contacts 22. Although two EMI compensation members 98 are shown, the housing body 62 may hold, and the contact sub-assembly 14 may include, any number of EMI compensation members 98. Alternatively, the housing body 62 may not hold any EMI compensation members 98.

The EMI compensation members 98 may have any suitable location, position, and orientation with respect to the array 24 of the electrical contacts 22, whether within or external to the housing body 62, that enables the EMI compensation members 98 to facilitate reducing or canceling excess signal noise of the array 24 of the electrical contacts 22. In the exemplary embodiment, each EMI compensation member body 100 extends through a corresponding opening 102 within the housing body 62. At least a portion of the body 100 engages the housing body 62 within the corresponding opening 102 to facilitate holding the EMI compensation member 98 in position within the housing body 62. In the exemplary embodiment, the EMI compensation member 98a is positioned within the housing body 62 on a side portion 104 of the array 24, while the EMI compensation member 98b is positioned within the housing body 62 on a side portion 106 of the array 24 that is opposite the side portion 104. The EMI compensation member 98a overlaps the intermediate portions 74 within the row 86 of the differential pairs 22b and 22c, while the EMI compensation member 98b overlaps the intermediate portions 74 within the row 88 of the differential pairs 22b and 22c. Alternatively, one or more of the EMI compensation members 98a and 98b may overlap more only one or more than two of the intermediate portions 74 of the electrical contacts 22 within the respective row 86 and 88.

In the exemplary embodiment, each of the EMI compensation members 98 comprises a three-dimensional shape that includes a pair of opposite surfaces 108 and 110 that are each substantially planar. However, the EMI compensation members 98 may each have any suitable size and/or shape that enable the EMI compensation members 98 to facilitate reducing or canceling excess signal noise of the array 24 of the electrical contacts 22.

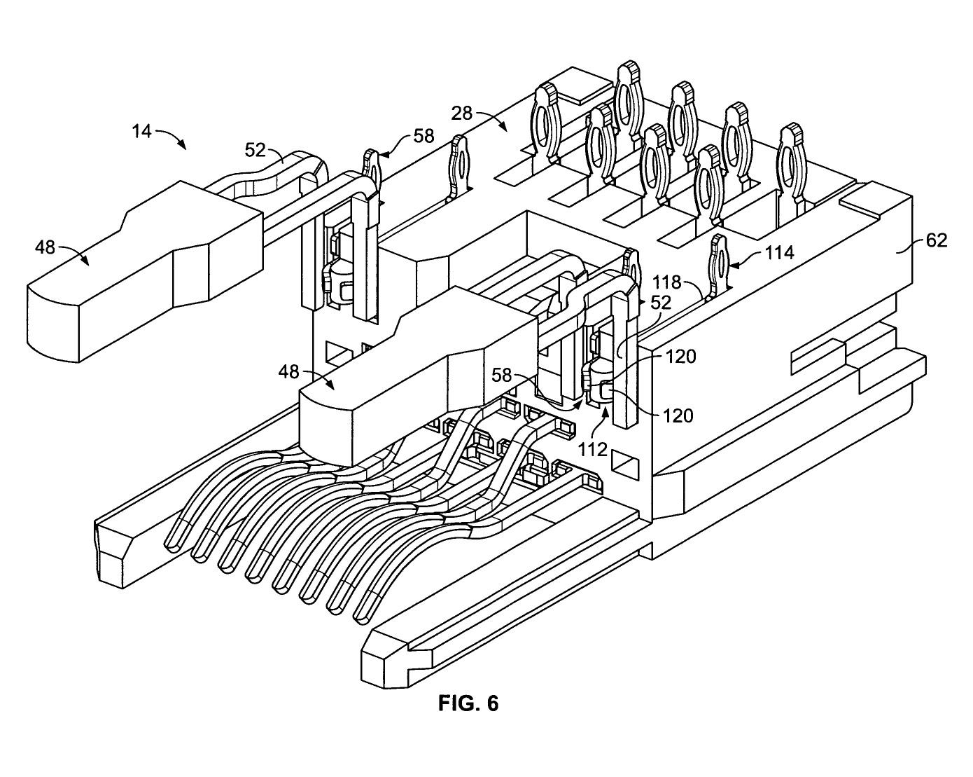

FIG. 6 is a perspective view of the contact sub-assembly 14 illustrating the LEDs 48 engaged with and electrically connected to the contact sub-assembly 14. Referring now to FIGS. 4 and 6, the housing body 62 holds the electrical contacts 58 of that engage and electrically connect to the electrical contacts 52 of the LEDs 48. Each of the contacts 58 includes a mating end portion 112, a tail end portion 114, and an intermediate portion (not shown) extending between the mating and tail end portions 112 and 114, respectively. The mating end portions 112 of the electrical contacts 58 extend along the front end portion 64 of the housing body 62. Each intermediate portion of the electrical contacts 58 extends through a corresponding opening 118 within the housing body 62 to the corresponding tail end portion 114, which extends along the mounting face 28 of the housing body 62. At least a portion of the intermediate portions of the electrical contacts 58 engage the housing body 62 within the corresponding opening 118 to facilitate holding the electrical contacts 58 in position relative to the housing body 62.

The tail end portions 114 of each of the electrical contacts 58 engage corresponding electrical contacts (not shown) on the circuit board to electrically connect the LED's 48 to the circuit board. Alternatively, the tail end portions 114 each electrically connect with a corresponding wire of a cable. In the exemplary embodiment, the tail end portions 114 of each of the electrical contacts 58 are configured as eye-of-the needle contacts. However, the tail end portions 114 of the electrical contacts 58 may each be configured as any suitable type of electrical contact, such as, but not limited to, pin contacts and/or insulation displacement contacts (IDCs). Moreover, in the exemplary embodiment, the tail end portions 114 of the electrical contacts 58 extend along the mounting face 28 in a direction substantially perpendicular to a direction at which the mating end portions 112 of the electrical contacts 58 extend. However, the tail end portions 114 may in extend any direction relative to the mating end portions 112, such as, but not limited to, substantially parallel. Although four electrical contacts 58 are shown, the contact sub-assembly 14 may hold nay number of electrical contacts 58 for electrical connection with any number of LEDs 48.

The mating end portions 112 of the electrical contacts 58 may be configured to engage and electrically connect to the electrical contacts 52 of the LEDs 48 using any suitable type of connection. In the exemplary embodiment, the electrical contacts 58 are each configured to engage the corresponding electrical contact 52 in a press-fit arrangement. The electrical contacts 58 and 52 may be configured for the press-fit arrangement using any suitable configuration, structure, means, and/or the like. In the exemplary embodiment, each of the electrical contacts 58 includes a pair of deflectable members 120 that, when engaged with the corresponding electrical contacts 52 of an LED 48, are moved inwardly toward each other against a bias. Stiction and/or friction resulting from the bias facilitates retaining the engagement and electrical connection between the contacts 52 and 58.

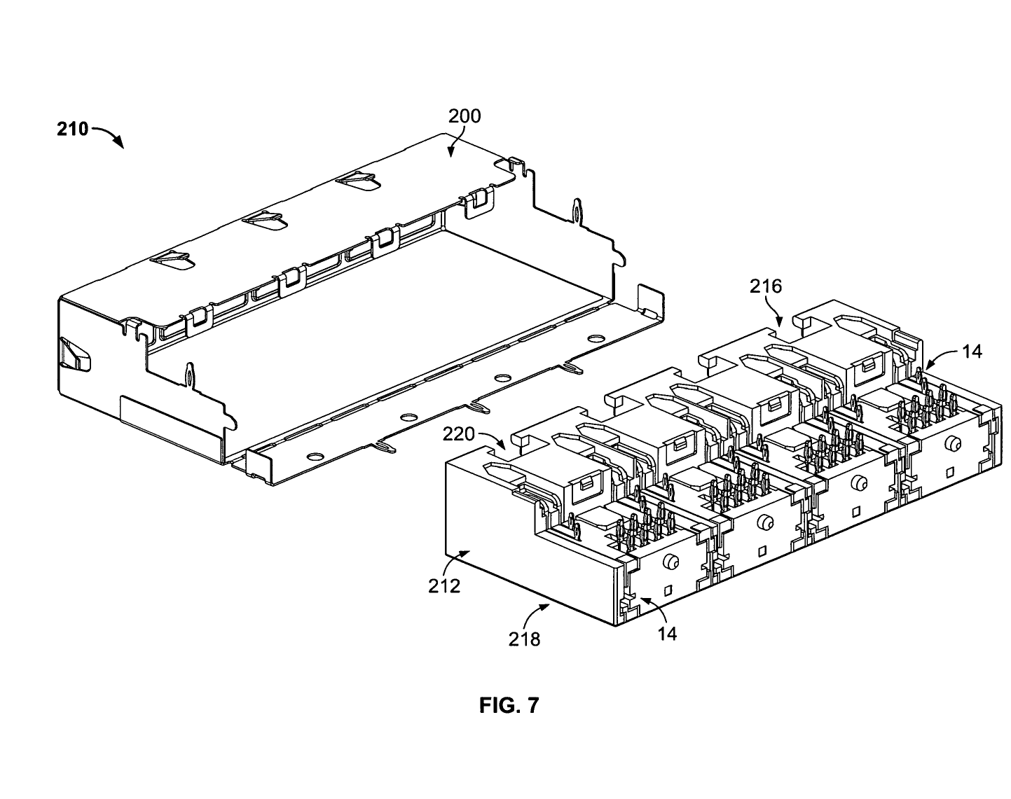

FIG. 7 is a partially exploded perspective view of an exemplary alternative embodiment of a receptacle connector assembly 210. The receptacle assembly 210 includes a housing 212 and a plurality of the contact sub-assemblies 14. The receptacle connector assembly 210 is modular in that a plurality of the same contact sub-assemblies 14 may be used to form one receptacle connector assembly. The housing 212 may be referred to herein as a front housing. The housing 212 extends between a front end portion 216 and an opposite rear end portion 218. The housing 212 includes a plurality of cavities 220 that extend through the front end portion 16. The contact sub-assemblies 14 are mated with the housing 212 through the rear end portion 218 such that the mating end portions 26 (FIGS. 3 and 4) of the electrical contacts 22 (FIGS. 3 and 4) are exposed within the corresponding cavity 220. In the example of FIG. 7, the cavities 220 each accepts an RJ-45 plug (not shown) inserted through the front end portion 216. Alternatively, one or more of the cavities 220 may accept other types of plugs. A shield 200 fabricated at least partially from an electrically conductive material surrounds a portion of the receptacle connector assembly 210. In the exemplary embodiment, the receptacle assembly 210 is configured to be mounted on a circuit board (not shown). Alternatively, the receptacle connector assembly 210 is configured to be mounted on the end of a cable (not shown).

Although the receptacle connector assembly 210 is shown as having four cavities 220 and four contact sub-assemblies 14 for electrically connecting four RJ-45 plugs (or alternatively other types of plugs) to a circuit board (or a plurality of cables), the assembly 210 may include any number of cavities 220 and any number contact sub-assemblies 14 for electrically connecting any number of plugs to the circuit board or any number of cables.

The embodiments described and/or illustrated herein may provide a receptacle connector assembly that reduces or eliminates EMI and/or cross-talk. The embodiments described and/or illustrated herein may also provide a receptacle connector assembly having an LED with less complex and/or expensive components.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step of one embodiment, can also be used in combination with other components and/or steps of other embodiments. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Moreover, the terms “first,” “second,” and “third,” etc. in the claims are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

While the invention has been described in terms of various specific embodiments, those skilled in the art will recognize that the invention can be practiced with modification within the spirit and scope of the claims.

1. A contact sub-assembly for a receptacle connector assembly, said contact sub-assembly comprising:
a housing comprising a body fabricated at least partially from a dielectric material;
a plurality of electrical contacts held by the housing, each of the electrical contacts having a mating end portion, a tail end portion opposite the mating end portion, and an intermediate portion extending between the mating and tail end portions, the intermediate portions of each of the electrical contacts comprising an edge, the edge of at least one of the intermediate portions having an indentation therein extending along a portion of a length of the edge.

2. A contact sub-assembly according to claim 1, wherein the intermediate portions of each of the electrical contacts includes a pair of substantially planar surfaces extending opposite each other, the edge extending between the pair of planar surfaces.

3. A contact sub-assembly according to claim 1, wherein the plurality of electrical contacts are held by the housing in an array having a row of the intermediate portions, the edge of the at least one intermediate portion having the indentation therein being the edge of the intermediate portion of an electrical contact positioned on an end of the row.

4. A contact sub-assembly according to claim 3, wherein the electrical contacts within the row are aligned along a longitudinal axis of the row.

5. A contact sub-assembly according to claim 1, wherein the plurality of electrical contacts are held by the housing in an array having a first row and a second row of the intermediate portions, the indentation being a first indentation of a first electrical contact, the edge of the intermediate portion of a second electrical contact having a second indentation therein, the first electrical contact being within the first row of the array and the second electrical contact being within the second row of the array.

6. A contact sub-assembly according to claim 1, wherein the indentation comprises an arcuate shape.

7. A contact sub-assembly according to claim 1, wherein the plurality of electrical contacts are first electrical contacts, the sub-assembly further comprising a second electrical contact configured to mate with a third electrical contact of a light emitting diode (LED) in a press-fit arrangement.

8. A contact sub-assembly according to claim 1, wherein the intermediate portions of the electrical contacts are held at least partially within the housing.

9. A contact sub-assembly according to claim 1, further comprising an EMI compensation member held at least partially within the housing and comprising a body fabricated at least partially from an electrically conductive material, the EMI compensation member facing the intermediate portion of at least one of the electrical contacts.

10. A contact sub-assembly according to claim 1, wherein the tail end portions of the electrical contacts are configured to mate with a circuit board.

11. A contact sub-assembly for a receptacle connector assembly, said contact sub-assembly comprising:
a housing comprising a body fabricated at least partially from a dielectric material;
a plurality of electrical contacts held by the housing, each of the electrical contacts having a mating end portion, a tail end portion opposite the mating end portion, and an intermediate portion extending between the mating and tail end portions; and
an EMI compensation member held at least partially within the housing and comprising a body fabricated at least partially from an electrically conductive material, the EMI compensation member facing the intermediate portion at least one of the electrical contacts.

12. A contact sub-assembly according to claim 11, wherein the EMI compensation member is held by the housing such that the EMI compensation member overlaps the intermediate portion of at least two of the electrical contacts.

13. A contact sub-assembly according to claim 11, wherein the EMI compensation member comprises a three-dimensional shape having a pair of opposite surfaces that each substantially planar.

14. A contact sub-assembly according to claim 11, wherein the plurality of electrical contacts are held by the housing in an array having a row of the intermediate portions, the EMI compensation member being a first EMI compensation member, the sub-assembly further comprising a second EMI compensation member.

15. A contact sub-assembly according to claim 11, wherein the plurality of electrical contacts are held by the housing in an array, the EMI compensation member being a first EMI compensation member, the sub-assembly further comprising a second EMI compensation member held at least partially within the housing, the first EMI compensation member extending on a first side portion of the array, the second EMI compensation member extending on a second side portion of the array that is opposite the first side portion.

16. A contact sub-assembly according to claim 11, wherein the EMI compensation member extends along at least a portion of the intermediate portion of at least one of the electrical contacts.

17. A contact sub-assembly according to claim 11, wherein the intermediate portions of the electrical contacts are held at least partially within the housing.

18. A receptacle connector assembly comprising:
a front housing extending between front and rear end portions, the front end portion being configured to receive a plug;
a contact sub-assembly held by the front housing, the contact sub-assembly comprising a sub-assembly housing comprising a body fabricated at least partially from a dielectric material, and a plurality of electrical contacts held by the sub-assembly housing, each of the electrical contacts having a mating end portion, a tail end portion opposite the mating end portion, and an intermediate portion extending between the mating and tail end portions; and
a light emitting diode (LED) connected to at least one of the front housing and the contact sub-assembly in a press-fit arrangement.

19. A receptacle connector assembly according to claim 18, wherein the plurality of electrical contacts are first electrical contacts, the sub-assembly further comprising a second electrical contact configured to mate with a third electrical contact of the LED in a press-fit arrangement.

20. A receptacle connector assembly according to claim 18, wherein the LED comprises a body mounted on the front housing in a press-fit arrangement.
